(19) United States
(12) Patent Application Publication
(10) Pub. No.: US 2011/0110507 A1
(43) Pub. Date: May 12, 2011

(54) System And Method For Communication Account Management

(75) Inventor: Wesley F. Spiegel, Richardson, TX (US)

(73) Assignee: CASHMate LLC, Richardson, TX (US)

(21) Appl. No.: 12/615,559

(22) Filed: Nov. 10, 2009

(51) Int. Cl. H04M 15/00

(52) U.S. Cl. 379/131

(57) ABSTRACT

According to one embodiment, a method includes receiving a notification of a first communication number from a first prime provider of a first institution. The method also includes determining a first account associated with the first communication number. The method also includes determining whether the first account includes sufficient funding for a first communication session involving the first communication number. The method includes sending a first message to the first prime provider indicating that the first account comprises sufficient funding for the first communication session. Further, the method includes receiving a notification of a second communication number from the first prime provider of the first institution. The method also includes determining that the second communication number is associated with the first account. The method also includes sending a second message to the first prime provider indicating that a communication session to the second communication number may proceed.

### TECHNICAL FIELD

This disclosure relates generally to communication sessions and more particularly to a system and method for charging communication sessions.

### BACKGROUND

Communication may exist in various forms between entities in various situations. Certain situations may require that communication sessions be charged to an account. For example, an inmate of a penal institution may desire to communicate with an outside party, such as a family member or a friend. A communication framework existing in the institution may require that the inmate be associated with an account that contains funds to charge for telephone calls placed by the inmate. Currently, such accounts are restricted to one telephone number per inmate per outside party. Establishing such accounts have been difficult because the outside party has been required to gather information such as an inmate's institution and serial number at the institution in order to establish the account. If the inmate is transferred to another institution or if the outside party would like to communicate with another inmate at the same or a different institution, the outside party must go through the expense and time of establishing a new account. In addition, as is now common, an outside party may have different telephone numbers that may be used to communicate with the inmate.

### SUMMARY

According to one embodiment, a method for communication account management includes receiving a notification of a first communication number from a first prime provider of a first institution. The first communication number is entered by a first inmate at the first institution and the first communication number is associated with a first user with which the first inmate desires to communicate. The method also includes determining a first account associated with the first communication number in response to receiving the notification of the first communication number. In response to determining that the first communication number is associated with the first account, the method includes determining whether the first account includes sufficient funding for a first communication session involving the first communication number. In addition, the method includes sending a first message to the first prime provider indicating that the first account comprises sufficient funding for the first communication session. Further, the method includes receiving a notification of a second communication number from the first prime provider of the first institution. The second communication number is entered by the first inmate at the first institution and the second communication number is associated with a user with which the first inmate desires to communicate. The method also includes determining that the second communication number is associated with the first account in response to receiving the notification of the second communication number. In response to determining that the second communication number is associated with the first account, the method includes sending a second message to the first prime provider indicating that a communication session to the second communication number may proceed.

In some embodiments, the method may include receiving a first session record from the first prime provider after sending the first message to the first prime provider. The first session record may include a duration of the first communication session. The method may also include reducing a value of the first account in response to the duration of the first communication session. In addition, the method may include receiving a second session record from the first prime provider after sending the second message to the first prime provider. The second session record may include a duration of the communication session to the second communication number. The method may include reducing the value of the first account in response to the duration of the communication session to the second communication number. In some embodiments, determining whether the first account has sufficient funding for the first communication session involving the first communication number includes determining whether the first account comprises sufficient funds to pay for an amount specified in the notification of the first communication number.

According to another embodiment, a system for communication account management includes a database comprising a first account. The system also includes at least one processor coupled to the database. The at least one processor is operable to receive a notification of a first communication number from a first prime provider of a first institution. The first communication number is entered by a first inmate at the first institution and the first communication number is associated with a first user with which the first inmate desires to communicate. The at least one processor is also operable to determine that the first communication number is associated with the first account in response to receiving the notification of the first communication number. In response to determining that the first communication number is associated with the first account, the at least one processor is operable to determine whether the first account comprises sufficient funding for a first communication session involving the first communication number. The at least one processor is also operable to send a first message to the first prime provider indicating that the first account comprises sufficient funding for the first communication session. The at least one processor is also operable to receive a second notification of the first communication number from the first prime provider of the first institution. The first communication number is entered by a second inmate at the first institution. In addition, the at least one processor is operable to determine that the first communication number is associated with the first account in response to receiving the second notification of the first communication number. In response to determining that the first communication number is associated with the first account, the at least one processor is operable to send a second message to the first prime provider indicating that a communication session to the first communication number involving the second inmate may proceed.

Depending on the specific features implemented, particular embodiments may exhibit some, none, or all of the following technical advantages. Communication sessions involving multiple inmates may be charged to the same account. A new account may not need to be established when an inmate moves to a different institution in order to communicate with the inmate at the new institution. An account may be associated with more than one communication address, providing flexibility in communication sessions between the inmate and an outside party.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

Reference is now made to the following description taken in conjunction with the accompanying drawings, wherein like reference numbers represent like parts and which:

FIG. 1 illustrates one embodiment of a system for charging communication sessions;

FIG. 2 illustrates an example computer system suitable for implementing one or more portions of particular embodiments of a system for charging communication sessions;

FIG. 3 is a flowchart illustrating how an account for charging communication sessions between a user and an inmate may be established in various embodiments; and

FIG. 4 is a flowchart illustrating how a communication session is established between an inmate and a user in various embodiments.

### DETAILED DESCRIPTION

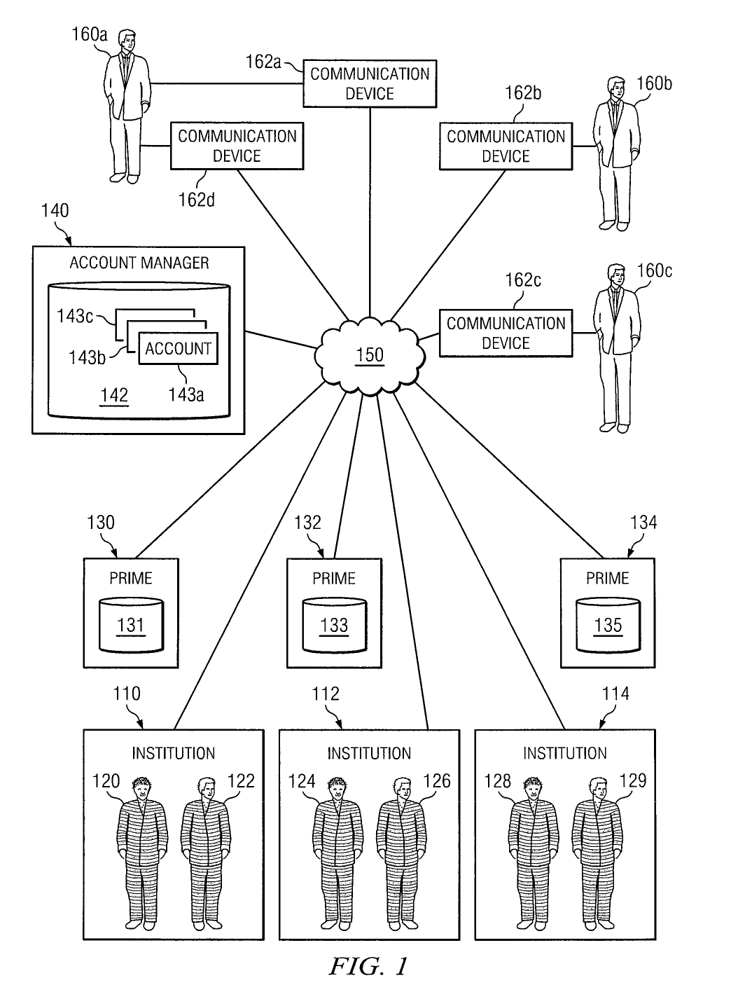

FIG. 1 illustrates one embodiment of system 100 for charging communication sessions. System 100 includes institutions 110, 112, and 114. Prime communication service providers (hereinafter “PRIMEs”) 130, 132, and 134 are coupled to institutions 110, 112, and 114, respectively. Account manager 140 is coupled to PRIMEs 130, 132, and 134 through network 150. Users 160a-c are coupled to communication devices 162a-c, respectively. Communication devices 162a-c are coupled to network 150. Inmates 120 and 122 reside in institution 110. Inmates 124 and 126 reside in institution 112. Inmates 128 and 129 reside in institution 114. PRIMEs 130, 132, and 134 include databases 131, 133, and 135, respectively. Account manager 140 includes database 142. Database 142 includes accounts 143a-c. In some embodiments, as further described below, system 100 may allow inmates 120, 122, 124, 126, 128, and 129 and users 160a-c to participate in communication sessions facilitated by PRIMEs 130, 132, and 134 by utilizing billing accounts 143a-c stored and maintained by account manager 140.

In some embodiments, institutions 110, 112, and 114 may include penal or correctional facilities such as jails or prisons. They may also include juvenile detention centers, crisis clinics, mental health institutions, hospitals, or other suitable venues where communication sessions may need to be charged. While the discussion is described in terms of providing communication services to inmates of institutions, the teachings of this disclosure may be used in other situations involving parties communicating in a manner that is charged to an account associated with one or more of the communicating parties.

In some embodiments, PRIMEs 130, 132, and 134 provide communication services to institutions 110, 112, and 114, respectively. In some embodiments, PRIMEs may be prime telephone service communication providers. In certain situations, PRIMEs 130, 132, and 134 may have an exclusive contractual relationship with institutions 110, 112, and 114, respectively, to provide communication services. Communication equipment within institutions 110, 112, and 114 may be coupled to suitable equipment in PRIMEs 130, 132, and 134. Such equipment may include one or more of the following: routers, gateways, switches, servers, trunk lines, adapters, hubs, PSTN connections, base stations, terminals, telephone stations, computer stations, and other equipment suitable for providing communication services. Communication services may include telephone communication services, messaging services, network access services, VOIP services, and/or other suitable communication services.

In various embodiments, inmates, such as inmates 120, 122, 124, 126, 128, and 129 of institutions 110, 112, and 114 may be provided with the ability to communicate with entities outside of institutions 110, 112, and 114 using services provided by PRIMEs 130, 132, and 134. For example, inmates 120, 122, 124, 126, 128, and 129 may be provided with the ability to place telephone calls to users 160a-c. In some embodiments, PRIMEs 130, 132, and 134 may provide institutions 110, 112, and 114, respectively, access to network 150 such that communication, such as telephone calls on a network, may occur. In some cases, a PRIME may be an exclusive provider and carrier of communication services to an institution such that an institution is associated with only one PRIME. PRIMEs 130, 132, and 134 may, in some embodiments, contract with communication providers and/or carriers to provide communication services to institutions 110, 112, and 114.

In various embodiments, PRIMEs 130, 132, and 134 may store information in databases 131, 133, and 135, respectively. Such information may include identification information regarding inmates, such as inmates 120, 122, 124, 126, 128, and 129; identification information may include institution identifiers (such as serial numbers or registration numbers assigned to inmates), names of institutions where inmates are located, and/or other suitable identification items. The information stored in databases 131, 133, and 135 may also include communication identifiers (such as telephone numbers, e-mail addresses, network addresses, network identifiers, and/or login identifiers) associated with inmates 120, 122, 124, 126, 128, and 129 or parties inmates 120, 122, 124, 126, 128, and 129 may contact, such as users 160a-c. The information may also include lists (such as whitelists or blacklists) that determine parties that may be contacted by inmates 120, 122, 124, 126, 128, and 129. In some situations, such lists may be determined based on security requirements used in institutions 110, 112, 114. PRIMEs 130, 132, and 134 may, in some embodiments, use the information to apply security policies to communication sessions. Information stored in databases 131, 133, and 135 may also include communication records. Such records may track parties contacted, duration of communication sessions, charges that may be applied to communication sessions, and/or other suitable aspects of communication sessions.

In some embodiments, account manager 140 may be configured to establish, maintain, and/or apply transactions to accounts 143a-c used for communication sessions facilitated by PRIMEs 130, 132, and 134. Account manager 140 may include communication equipment configured to receive information related to establishing, maintaining, and/or applying transactions to accounts 143a-c. Such information may be received by users 160a-c and/or PRIMEs 130, 32, and 134 in various embodiments. Account manager 140 may include processing and/or memory elements that may facilitate establishing, maintaining, and/or applying transactions to accounts 143a-c. Database 142 may also be used to facilitate such activities in account manager 140. Database 142 may, in various embodiments, include information such as account numbers, account balances, communication records, transaction records, inmate identifiers, primary communication addresses associated with accounts, secondary communication addresses associated with accounts, login and password information, primary communication service provider information, and/or other suitable items that facilitate the establishment, maintenance, and/or application of transactions to accounts. Such information may be stored in accounts 143a-c. The processing elements (e.g., one or more processors) may be coupled to database 142 to establish, maintain, and/or apply transactions to accounts 143a-c used for communication sessions facilitated by PRIMEs 130, 132, and 134.

In various embodiments, account manager 140 may include components or modules that may be distributed across various networks. Such items may include Interactive Voice Response (IVR) modules, Web sites, kiosks, ATM machines, terminals in retail or other locations accessible by members of the public and/or through vendors. For example, users 160a-c may utilize one or more of these items to establish accounts 143a-c, respectively, provide information regarding communication addresses (e.g., telephone numbers and/or e-mail addresses) to be associated with accounts 143a-c, provide funding for accounts 143a-c, and/or retrieve information about accounts 143a-c. Account manager 140 may communicate with such components or modules using network 150 and/or other suitable communication infrastructures.

Databases 131, 133, 135 and 142 may be implemented using a variety of database structures. Each of these databases may include one more databases. The databases may be row-oriented or column-oriented. They may include relational databases and/or object-oriented databases. Databases 131, 133, 135 and 142 may be indexed and accessed in a variety of manners, including by utilizing an operating system or through one or more networks. In some embodiments, database 142 may hold some or all of the information held in databases 131, 133, and 135. In particular embodiments, databases 131, 133, and/or 135 may hold some or all of the information held in database 142.

Network 150, in some embodiments, may be a communicative platform operable to exchange data, information, and/or media (such as video and/or voice). Network 150 may represent one or more networks. These networks may include a plain old telephone system (POTS). In various embodiments, the networks may include packet data networks offering communication interfaces or exchanges between any two nodes in system 100. Network 150 may be or include any local area network (LAN), Private Branch Exchange (PBX) network, metropolitan area network (MAN), wide area network (WAN), wireless local area network (WLAN), virtual private network (VPN), intranet, Internet, or any other appropriate architecture or system that facilitates communications in a network or telephonic environment, including a combination of any networks or systems described above. The networks may also include wireless technology such as WiMAX, LTE, or any of a variety of cellular networks.

In some embodiments, communication devices 162a-c represent (and are inclusive of) telephones that may be used to access network 150. Alternatively, communication devices 162 may be representative of landline telephones, cellular telephones, VOIP telephones, softphones, PBX telephones, computers, electronic notebooks, laptops, personal digital assistants (PDAs), or any other suitable devices, components, or elements capable of participating in communication sessions.

In some embodiments, inmates 120, 122, 124, 126, 128, and 129 and users 160a-c may be people that desire to enter into communication sessions. For example, users 160a-c may be friends and/or family of inmates 120, 122, 124, 126, 128, and 129. Inmates 120, 122, 124, 126, 128, and 129 may be provided restricted access to communication. For example, in scenarios where inmates 120, 122, 124, 126, 128, and 129 are incarcerated in institutions 110, 112, and 114, inmates 120, 122, 124, 126, 128, and 129 may have restricted access to communication devices such as telephones. In this and other scenarios, users 160a-c may be provided opportunities to communicate with inmates 120, 122, 124, 126, 128, and 129 through communication frameworks facilitated by PRIMEs 130, 132, and/or 134. Such communication sessions may be charged to either users 160a-c and/or inmates 120, 122, 124, 126, 128, and 129.

In some embodiments, communication addresses may be associated with users 160a-c and/or with communication devices 162a-d. For example, a communication address associated with communication device 162a may also be considered to be associated with user 160a because user 160a is associated with communication device 162a. As another example, a communication address may be associated with user 160a and either communication device 162a and/or 162d may be considered to be associated with the communication address because communication devices 162a and 162d are associated with user 160a.

In operation, in various embodiments, system 100 may facilitate one or more communication sessions between users 160a-c and inmates 120, 122, 124, 126, 128, and 129. In order to participate in such communication sessions, any of users 160a-c may establish an account with account manager 140, such as accounts 143a-c. This may be accomplished using items such as IVRs, Web sites, terminals, or through vendors. In establishing account 143a, for example, one or more of inmates 120, 122, 124, 126, 128, and 129 across one or more institutions 110, 112, and 114 may be associated with account 143a. In some embodiments, accounts 143a-c are not specifically associated with any of inmates 120, 122, 124, 126, 128, and 129, providing a benefit to users 160a-c in that they do not need to provide inmate identifying information in order to establish and/or utilize an account. In addition, in various embodiments, one or more communication addresses (e.g., telephone numbers or e-mail addresses) may be associated with account 143a. Funds may also be placed into account 143a. Such activity may also occur with respect to accounts 143b-c. As further described below, communication sessions between users and inmates may be charged to accounts 143a-c. In some embodiments, one or more of inmates 120, 122, 124, 126, 128, and 129 may establish one or more of accounts 143a-c.

In various embodiments, the user establishing the account need only provide the name of the inmate in order to identify who should be associated with the account. In some cases, the user may not need to identify a PRIME to be associated with the account. This may be advantageous in that it may be difficult for the user to determine information regarding an inmate, such as a serial number or the name of the institution where the inmate resides or the PRIME associated with the institution. Acquiring such information may be time-consuming and expensive, delaying communication between the user and the inmate.

In some embodiments, inmate 120 may desire to enter a communication session with user 160a from within institution 110. Inmate 120 may enter a communication address, such as a telephone number, associated with communication device 162a, such as a telephone number. PRIME 130 may receive the entered communication address and verify that inmate 120 may communicate with that address utilizing database 131. PRIME 130 may then send a validation request to account manager 140 to determine if an account associated with the communication address, such as account 143a, has sufficient funds for the communication session. In some embodiments, the validation request may ask if the account has an amount of funds sufficient to cover a call of a maximum duration allowed by institution 110 or PRIME 130. Based on the communication address, account manager 140 may access account 143a associated with user 160a and determine if sufficient funds exist. In some embodiments, account manager 140 may find any account 143 associated with the entered communication address. If sufficient funds exist, account manager 140 may provide an indication to PRIME 130 that the funds exist which may cause PRIME 130 to establish the communication session. The session may be charged to account 143a after it has been completed. For example, account manager 140 may receive a record from PRIME 130 indicating the duration of the communication session. Using this, account manager 140 may determine the amount of funds to deduct from account 143a.

In some embodiments, inmate 120 may attempt to communicate with user 160a using a communication address (e.g., a telephone number) associated with communication device 162d. In such situations, after PRIME 130 has verified that inmate 120 may communicate with that address (e.g., by applying security rules), account manager 140 may identify account 143a established by user 160a as being associated with the communication address of communication device 162d. The communication session involving the communication address of communication device 162d may be charged to account 143a as was the communication session involving the communication address of communication device 162a. This may be advantageous in scenarios where user 160a would like to communicate using multiple addresses (e.g., multiple telephone numbers such as a home telephone number and a work telephone number) without having to maintain separate accounts. This may also provide an advantage to the user and the inmate in that it may provide for more flexible communication sessions since more than one address may be used to contact the user. Being able to utilize more than one number may also enable other users, such as users 160b and 160c (e.g., using communication devices 162b and 162c, respectively), to communicate with an inmate using the same account (i.e., account 143a). For example, if users 160a-c are part of the same family or group of friends attempting to communicate with inmate 120, they all may be able to utilize account 143a which would allow them to save time and money by avoiding the need to establish multiple accounts in order to communicate with the addresses associated with users 160a-c.

In some embodiments, user 160a may desire to communicate with multiple inmates through a single account. User 160a may create account 143a within account manager 140 that identifies these inmates, such as inmates 120 and 122. In such scenarios, PRIME 130 may send requests to communicate from inmates 120 and 122 to account manager 140. Account manager 140 may associate each of the requests to communicate with account 143a. As a result, communication sessions between inmate 120 and user 160a and inmate 122 and user 160a may be charged to account 143a. For example, account manager 140 may receive records from PRIME 130 indicating the duration of the communication sessions between inmate 120 and user 160a and inmate 122 and user 160a. Using this, account manager 140 may determine the amount of funds to deduct from account 143a. In various embodiments, this may be advantageous in that one account (in this example, account 143a) may be used to communicate with multiple inmates obviating the need for multiple accounts which may save users, such as user 160a, time and money establishing the various accounts since users may not have to pay account management fees and/or transaction fees associated with multiple accounts. This may overcome the restrictive nature of current situations at institutions where a single account can only be associated with one inmate and one number due to the system architectures and/or rules of the institutions and/or the PRIME.

In some embodiments, user 160a may desire to communicate with one or more inmates in multiple institutions. For example, user 160a may desire to communicate with inmate 120 in institution 110 and inmate 124 in institution 112. When inmate 120 attempts to communicate with user 160a using a communication address associated with user 160a, PRIME 130 sends a validation request to account manager 140 in order to determine if sufficient funds exist for the session. When inmate 124 attempts to communicate with user 160a using the communication address associated with user 160a, PRIME 132 sends a validation request to account manager 140 in order to determine if sufficient funds exist for the session. Since user 160a has associated account 143a with the communication address entered by both inmates 120 and 124, account manager 140 may use account 143a to provide funding for communication sessions involving inmates 120 and 124. In some embodiments, user 160a may not need to indicate which institutions or PRIMEs inmates 120 and 124 are associated with when establishing account 143a. This may be advantageous in that user 160a may use the same account to communicate with inmates in different institutions that are associated with different PRIMEs. This may prevent user 160a from having to establish multiple accounts which may be costly and time-intensive. Further, in scenarios where the same inmate may move from one institution to another, the same account (i.e., account 143a) may be used to provide funding for communication sessions involving the inmate. This may obviate the need for a user, such as user 160a, to establish a new account each time an inmate moves to another institution, providing for faster and easier communication sessions as well as cost savings. In some embodiments, an inmate moving from one institution to another may not require any changes to be made by the user in order to communicate with the inmate at the new institution.

In some embodiments, PRIME 130 may not have a relationship (contractual or otherwise) with account manager 140. In such situations, an account established by a user may not be used for communication sessions associated with PRIME 130. For example, if inmate 120 enters a communication address associated with user 160a, PRIME 130 may not utilize account manager 140 for billing the communication session even though account manager 140 includes account 143a that is associated with user 160a and the communication address entered by inmate 120. In such situations, account manager 140 may not receive any messages from PRIME 130 regarding the communication session between inmate 120 and user 160a.

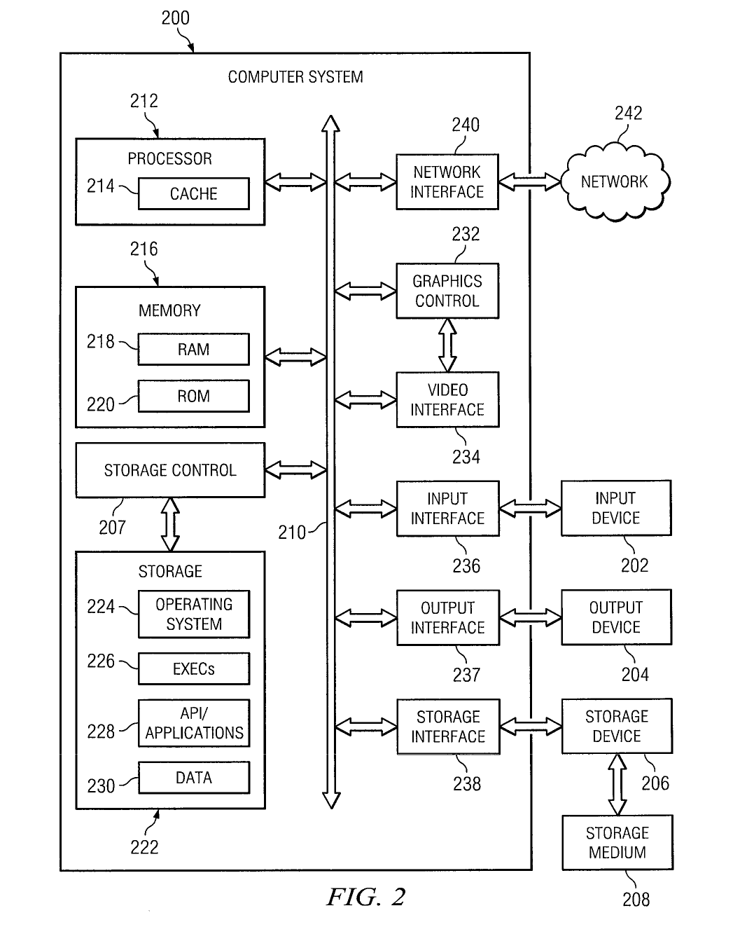

FIG. 2 illustrates an example computer system 200 suitable for implementing one or more portions of particular embodiments of a system for charging communication sessions. Although the present disclosure describes and illustrates a particular computer system 200 having particular components in a particular configuration, the present disclosure contemplates any suitable computer system having any suitable components in any suitable configuration. Moreover, computer system 200 may have take any suitable physical form, such as for example one or more integrated circuit (ICs), one or more printed circuit boards (PCBs), one or more handheld or other devices (such as mobile telephones or PDAs), one or more personal computers, or one or more super computers. PRIMEs 133, 132, and 134, databases 131, 133, 135, and 142, account manager 140, communication devices 162a-c, and other components discussed above with respect to FIG. 1 may be implemented using all of the components, or any appropriate combination of the components, of computer system 200 described below.

Computer system 200 may have one or more input devices 202 (which may include a keypad, keyboard, mouse, stylus, etc.), one or more output devices 204 (which may include one or more displays, one or more speakers, one or more printers, etc.), one or more storage devices 206, and one or more storage medium 208. An input device 202 may be external or internal to computer system 200. An output device 204 may be external or internal to computer system 200. A storage device 206 may be external or internal to computer system 200. A storage medium 208 may be external or internal to computer system 200.

System bus 210 couples subsystems of computer system 200 to each other. Herein, reference to a bus encompasses one or more digital signal lines serving a common function. The present disclosure contemplates any suitable system bus 210 including any suitable bus structures (such as one or more memory buses, one or more peripheral buses, one or more a local buses, or a combination of the foregoing) having any suitable bus architectures. Example bus architectures include, but are not limited to, Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

Computer system 200 includes one or more processors 212 (or central processing units (CPUs)). A processor 212 may contain a cache 214 for temporary local storage of instructions, data, or computer addresses. Processors 212 are coupled to one or more storage devices, including memory 216. Memory 216 may include random access memory (RAM) 218 and read-only memory (ROM) 220. Data and instructions may transfer bidirectionally between processors 212 and RAM 218. Data and instructions may transfer unidirectionally to processors 212 from ROM 220. RAM 218 and ROM 220 may include any suitable computer-readable storage media. Computer system 200 includes fixed storage 222 coupled bi-directionally to processors 212. Fixed storage 222 may be coupled to processors 212 via storage control unit 207. Fixed storage 222 may provide additional data storage capacity and may include any suitable computer-readable storage media. Fixed storage 222 may store an operating system (OS) 224, one or more executables (EXECs) 226, one or more applications or programs 228, data 230 and the like. Fixed storage 222 is typically a secondary storage medium (such as a hard disk) that is slower than primary storage. In appropriate cases, the information stored by fixed storage 222 may be incorporated as virtual memory into memory 216. The embodiments described above with respect to memory 216 and fixed storage 222 may be suitable to implement databases 131, 133, 135, and 142 of FIG. 1.

Processors 212 may be coupled to a variety of interfaces, such as, for example, graphics control 232, video interface 234, input interface 236, output interface 237, and storage interface 238, which in turn may be respectively coupled to appropriate devices. Example input or output devices include, but are not limited to, video displays, track balls, mice, keyboards, microphones, touch-sensitive displays, transducer card readers, magnetic or paper tape readers, tablets, styli, voice or handwriting recognizers, biometrics readers, or computer systems.

Network interface 240 may couple processors 212 to another computer system or to network 242. Network interface 240 may include wired, wireless, or any combination of wired and wireless components. Such components may include wired network cards, wireless network cards, radios, antennas, cables, or any other appropriate components. With network interface 240, processors 212 may receive or send information from or to network 242 in the course of performing steps of particular embodiments. Particular embodiments may execute solely on processors 212. Particular embodiments may execute on processors 212 and on one or more remote processors operating together.

In a network environment, where computer system 200 is connected to network 242, computer system 200 may communicate with other devices connected to network 242. Computer system 200 may communicate with network 242 via network interface 240. For example, computer system 200 may receive information (such as a request or a response from another device) from network 242 in the form of one or more incoming packets at network interface 240 and memory 216 may store the incoming packets for subsequent processing. Computer system 200 may send information (such as a request or a response to another device) to network 242 in the form of one or more outgoing packets from network interface 240, which memory 216 may store prior to being sent. Processors 212 may access an incoming or outgoing packet in memory 216 to process it, according to particular needs. In various embodiments, such activity may be used to implement aspects of PRIMEs 130, 132, and 134, institutions 110, 112, and 114, as well as account manager 140 of FIG. 1.

Particular embodiments involve one or more computer-storage products that include one or more tangible, computer-readable storage media that embody software for performing one or more steps of one or more processes described or illustrated herein. In particular embodiments, one or more portions of the media, the software, or both may be designed and manufactured specifically to perform one or more steps of one or more processes described or illustrated herein. In addition or as an alternative, in particular embodiments, one or more portions of the media, the software, or both may be generally available without design or manufacture specific to processes described or illustrated herein. Example computer-readable storage media include, but are not limited to, CDs (such as CD-ROMs), FPGAs, floppy disks, optical disks, hard disks, holographic storage devices, ICs (such as ASICs), magnetic tape, caches, PLDs, RAM devices, ROM devices, semiconductor memory devices, and other suitable computer-readable storage media. In particular embodiments, software may be machine code which a compiler may generate or one or more files containing higher-level code which a computer may execute using an interpreter.

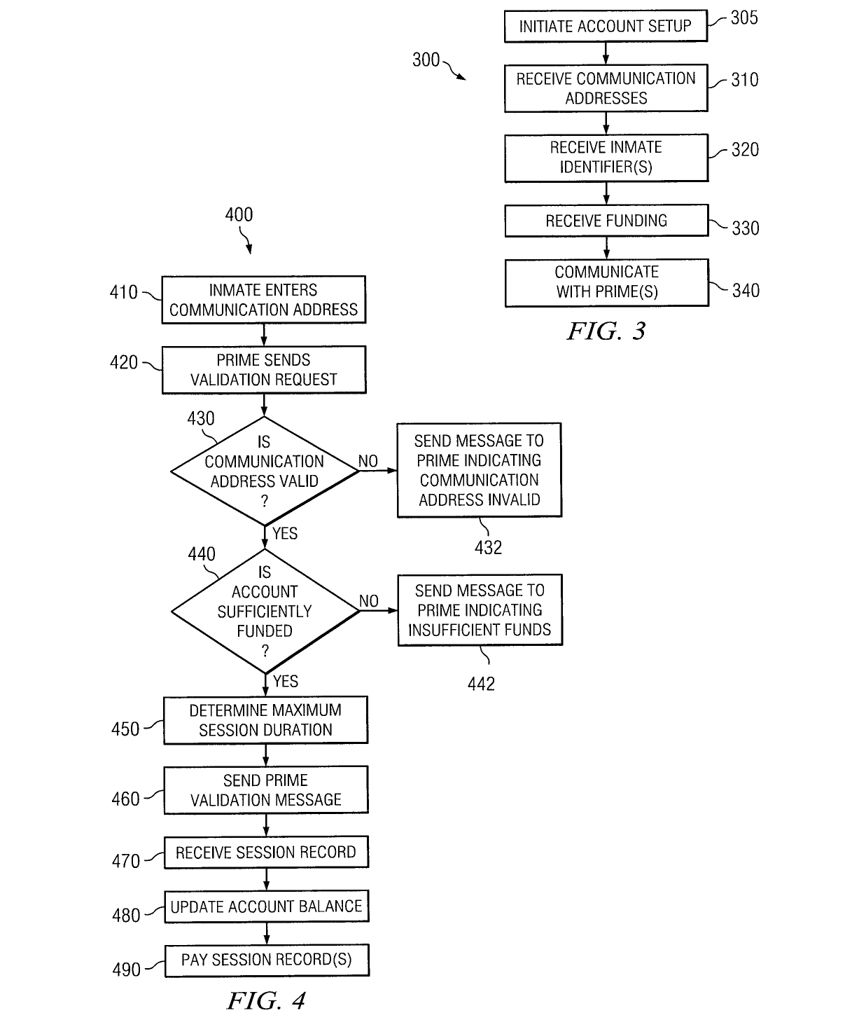

As an example and not by way of limitation, memory 216 may include one or more computer-readable storage media embodying software and computer system 200 may provide particular functionality described or illustrated herein as a result of processors 212 executing the software. Such a configuration may, in various embodiments, be suitable for implementing aspects of PRIMEs 130, 132, and 134 as well as account manager 140 of FIG. 1. Memory 216 may store and processors 212 may execute the software. Memory 216 may read the software from the computer-readable storage media in mass storage device 216 embodying the software or from one or more other sources via network interface 240. When executing the software, processors 212 may perform one or more steps of one or more processes described or illustrated herein (for example, operations of PRIMEs 130, 132, and 134 as well as account manager 140 of FIG. 1 or steps described in FIGS. 3-4), which may include defining one or more data structures for storage in memory 216 and modifying one or more of the data structures as directed by one or more portions the software, according to particular needs.

In some embodiments, the described processing and memory elements (such as processors 212 and memory 216) may be distributed across multiple devices such that the operations performed utilizing these elements may also be distributed across multiple devices. For example, software operated utilizing these elements may be run across multiple computers that contain these processing and memory elements. Other variations aside from the stated example are contemplated involving the use of distributed computing.

In addition or as an alternative, computer system 200 may provide particular functionality described or illustrated herein as a result of logic hardwired or otherwise embodied in a circuit, which may operate in place of or together with software to perform one or more steps of one or more processes described or illustrated herein. The present disclosure encompasses any suitable combination of hardware and software, according to particular needs.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

FIGS. 3-4 are flowcharts that illustrate various embodiments of the operation of a communication system. In general, the steps illustrated in FIGS. 3-4 may be combined, modified, or deleted where appropriate, and additional steps may also be added to the example operation. Furthermore, the described steps may be performed in any suitable order. In some embodiments, the steps described below may be performed by any suitable combination of the elements discussed above with respect to FIGS. 1-2.

FIG. 3 is a flowchart illustrating how an account for charging communication sessions between a user and an inmate may be established in various embodiments. At step 305, in various embodiments, a user initiates an account setup routine. A variety of interfaces may be used to setup an account. Examples include an interface through a network (such as the Internet), an IVR interface, a terminal interface, and a vendor interface. A terminal interface may include utilizing an automated kiosk-like device. A vendor interface may include interacting with an employee of a business, where a user establishing an account communicates information to the employee who, in turn, sets up the account for the user. Each of these interfaces are used to setup the account with an account manager.

At step 310, in some embodiments, communication addresses are received to be associated with the account. These addresses may be of the same type or different types. Types of addresses include Session Initiation Protocol (SIP) identifiers, telephone numbers, network addresses, subdomain identifiers, e-mail addresses, instant message identifiers, or other suitable communication addresses. In some embodiments, an account may be identified using one of the communication addresses as a primary communication address. Other communication addresses may be listed as secondary communication addresses in the account and may correspond to one or more communication devices used by the one or more uses. For example, an account number may be the same as the primary communication address, such as a telephone number. This may be advantageous in that it provides a memorable account number for the user. The different communication addresses may be associated with one or more users of the account. For example, a user may have multiple telephones (such as a home telephone and a mobile telephone) that the user would like to use in a communication session. As an other example, a user and a family member of the user may use communication devices whose communication addresses (e.g., telephone numbers) may be associated with the same account such that if the user or the user's family member participate in a communication session with an inmate, the same account will be charged.

At step 320, in some embodiments, one or more identifiers associated with one or more inmates are received. In some embodiments, the identifiers may be the name(s) of the inmate(s). The identifiers received at this step may also include other forms of identification, such as Social Security numbers, driver's license numbers, passport numbers, or numbers assigned to the inmate(s) at the institution where they reside. In various embodiments, information such as the identity of the PRIME and/or institution, or other such information associated with the inmate may be provided. Embodiments where a user merely supplies information that is readily-available to the user (such as the inmate's name or Social Security number) may be advantageous in that accounts may be established in a shorter time frame at less expense since the user does not have to research the details of the inmate's current or past institutions. Embodiments where a user may supply identifiers for more than one inmate may also be advantageous because a user may be able to manage communication with more than one inmate from one account, saving the user the time and expense of establishing an account for each inmate. In some embodiments, accounts may be established without entering any information regarding inmates. In such cases, step 320 may not be performed.

At step 330, in some embodiments, funding for the account may be received from the user. A variety of payment options may be used at this step, either alone or in combination. For example, a user may use credit cards, debit cards, cash cards, and/or vouchers. A user may also provide cash or a check, in some embodiments, when using vendor or terminal interfaces in establishing the account. Wire or electronic transfers, in various embodiments, may be used by a user to fund an account. Deposited funds may be credited to the account while the actual funds may be placed in a bank account affiliated with the account manager, including, for example, an escrow account.

At step 340, in some embodiments, the account manager may communicate with one or more PRIMEs to further facilitate the establishment of the account. For example, the account manager may use the inmate identifiers received at step 320 to identify PRIMEs and/or institutions associated with the inmate. As another example, the account manager may inform the PRIMEs of the existence of the account, enabling the PRIMEs to identify the account manager as the entity through which certain communication sessions should be billed. For example, the account manager may communicate to the PRIME that a particular communication address has been associated with an account managed by the account manager. In some embodiments, the account manager may communicate with the PRIMEs to determine rules associated with the institution regarding communication sessions. Such rules, for example, may include duration limits on communication sessions, rates applied to communication sessions, or other suitable restrictions regarding communication sessions. These rules may be associated with the account. If inmate identifiers are associated with the account and the inmate identifiers include inmates at more than one institution, then, in some embodiments, rules from the associated institutions may be received and associated with the account as well as the inmate to which they apply within the account. In various embodiments, accounts may not include any information regarding inmates. In such embodiments and other embodiments, rules from one or more PRIMEs or institutions may be associated with the account or associated with one or more communication addresses included within the account.

In various embodiments, the steps listed above may be performed in a different order. For example, funding may be received (step 340) before the inmate identifier(s) (step 320). In addition, not all of the steps need to be performed in various embodiments. For example, a user may increase the amount of funds in an already-existing account by performing steps 305 and 330. As another example, a user may update the communication addresses associated with the account by performing steps 305 and 310. In yet another example, a user may add or remove an inmate from the account by performing steps 305 and 320. In this case, during step 320, the user may send one or more inmate identifiers with an indicator as to whether the associated inmate(s) should be added or removed from the account.

FIG. 4 is a flowchart illustrating how a communication session is established between an inmate and a user in various embodiments. At step 410, the inmate enters a communication address associated with the user (e.g., a telephone number) into a communication device in the institution. In some embodiments, the equipment or personnel at the institution may verify that the inmate may communicate with this communication address. This may be determined using rules, including security rules. The PRIME associated with the institution receives the entered communication address and, in some embodiments, may determine if the desired communication session is allowed. This may be done in conjunction with or apart from the institution. For example, the institution may enforce certain restrictions on communication sessions while the PRIME enforces other restrictions on communication sessions. In some cases, the institution may not enforce restrictions and, instead, inform the PRIME as to how the PRIME should enforce restrictions on communication sessions. Restrictions applied by the PRIME and/or the institution may include security rules.

At step 420, in some embodiments, the PRIME may send a validation request to an account manager. The validation request may be sent to determine if there are sufficient funds to establish the communication session and/or to determine how long the communication session should last with respect to the amount of funds available. The request may contain some or all of the following information: inmate identifiers (e.g., name, serial number), the entered communication address, PRIME identifier(s) (e.g., name, account number), institution identifier(s) (e.g., name, number), party associated with the entered communication address, one or more rules governing the communication session, and account number associated with the inmate. In some embodiments, the validation request may ask if the account has a certain amount of funds available, such as an amount of funds sufficient to cover a call of a maximum duration allowed by the inmate's institution or PRIME. For example, if the PRIME applies a rate of $0.10 per minute for the communication session and only allows communication sessions to last for 30 minutes, the validation request sent by the PRIME may ask the account manager if an associated account has enough funds for a $3.00 communication session.

At step 430, in some embodiments, the account manager may determine if the entered communication address is valid. This may occur by determining if the communication address is associated with any account managed by the account manager. In some embodiments, the account manager may determine if the communication address is one of a plurality of communication addresses associated with an account. In some cases, an account may contain a primary communication address and several secondary communication addresses. In such situations, the account manager may determine if the communication address entered at step 410 corresponds to either primary or secondary communication addresses. In some embodiments, the account manager may use other information contained in the request for validation sent from the PRIME to access an account and determine if the entered communication address is valid. For example, the account manager may access one or more accounts based on inmate identifiers or the identity of the party associated with the entered communication address. These accounts are then analyzed to determine if a communication session involving the entered communication address may be charged to the account. The account manager may also determine if communication sessions with the inmate are allowed utilizing the identified account. In some embodiments where inmates are identified in the validation request, this may be done by examining if one or more identifiers (such as a name, Social Security number, and/or institution serial number) correspond with the inmate identified in the validation request. If the account manager determines that the communication address is not valid (i.e., the communication address is not associated with an account and/or the inmate is not associated with an account that is associated with the communication address), a message may be sent to the PRIME indicating that the communication address is not valid (as in step 432). If it is determined that the communication address is valid, then step 440 may be performed. In some embodiments, the PRIME may perform screening on the entered communication addresses such that step 430 may not be performed by the account manager. For example, the PRIME (through prior communication with the account manager) may be able to determine if the communication address is valid. As a result, account manager may not make that determination and step 430 may not be performed. In some situations where step 430 is not performed by the account manager, step 440 may be performed after step 420.

At step 440, in some embodiments, the funds available in the account identified at step 430 are analyzed to determine if they are sufficient to support a communication session with the communication address. The account manager may determine the amount of funds available in the account. In some embodiments, the account manager may determine a rate to apply to the communication session. This may be based on various factors, such as the type of communication session (e.g., telephone call, VOIP call, video call, or messaging), the communication address (e.g., a long distance phone number, an international phone number, a mobile telephone number, the communication provider associated with the communication address, or a number associated with a VOIP provider), the PRIME associated with the inmate, and/or other suitable factors. In some embodiments, the account manager may determine the minimum duration of a communication session based on the determined rate and account balance. Rules may be used to determine if this determined minimum duration is sufficient. Such rules may be provided by the PRIME and/or the account manager.

In some embodiments, the account manager may determine if the funds in the account are sufficient to cover an amount sent by the PRIME at step 420. For example, the validation request sent by the PRIME at step 420 may include a query to determine if the account contains funds for a specific amount. This amount may have been determined by the PRIME based on the rate applied to the communication session as well as a maximum duration of the communication session for the inmate making the call.

At step 440, if the account manager determines that the account is not sufficiently funded, a message may be sent to the PRIME indicating that there are insufficient funds to establish the communication session (step 442). If the funds are deemed sufficient, step 450 may be performed.

At step 450, in some embodiments, the account manager may determine the maximum amount of time a communication session involving the communication address entered at step 410 should last. In some embodiments, as in step 440, the account balance is compared to the applicable rate to determine the maximum duration of such a communication session. The maximum duration of the communication session may also be determined in accordance with rules promulgated by the account manager or the PRIME. For example, the PRIME may require that communication sessions last no more than 20 minutes. Such rules may be based on the institution, inmate, and/or the communication address. For example, an inmate may receive a punishment that limits the amount of communication sessions the inmate may participate in. The PRIME may have sent such information to the account manager at step 420. In various embodiments, the account manager may analyze both funds available in the account as well as applicable rules to determine the maximum duration of the communication session. In some embodiments, the account manager may not perform step 450. For example, the validation request sent by the PRIME at step 420 may include a query as to whether the account has enough funding to support a specified amount. This amount may have been determined by the PRIME based on the rate applied to the communication session as well as the maximum duration of the communication session. The maximum duration may be based on inmate or institution-specific rule in some embodiments. Once the account manager makes a determination as to whether the account has sufficient funding (i.e., in step 440), the account manager may proceed to step 460 and not perform step 450.

At step 460, in some embodiments, the account manager may send the PRIME a validation message. The message may indicate that the communication address entered at step 410 is associated with a valid account with sufficient funds for a communication session. The message may, in the alternative or in addition to the above, include minimum and/or maximum durations for the communication session. In situations where the validation request sent by the PRIME at step 420 contains a query as to whether the account has enough funding to support an amount specified in the validation request, the account manager may send a message to the PRIME in step 460 that either confirms or denies that the account has sufficient funds in accordance with the amount specified in the validation request. In some embodiments, the message at step 460 may need to be sent to the PRIME within a determined period of time from when the validation request from the PRIME is sent or received (i.e., at step 420). For example, this period of time may be nine seconds. This may ensure that the PRIME may be able to establish communication sessions in a timely fashion and so that the PRIME may be able to establish as many communication sessions as feasible.

At step 470, in some embodiments, the account manager may receive a session record from the PRIME. This record may indicate details regarding the communication session involving the communication address sent at step 410 after the session has been completed. Such details may include the duration of the session and information identifying the communication session, such as the inmate, the communication address used, timestamps as to when the session was initiated and terminated, PRIME identification, institution identification, account identification and/or other suitable information identifying the communication session. In some embodiments, the record may include an amount of funds to deduct from an account. At step 480, the account manager may use the information received at step 470 to update an account's balance. For example, the duration of the communication session may be used to calculate the amount of funds that should be deducted from the account. As another example, funds may be deducted from the account based on an amount specified at step 470.

At step 490, in some embodiments, the account manager may pay the PRIME based on communication session records it has received. The account manager may store records associated with completed communication sessions and periodically transfer funds to the PRIME based on these records. In various embodiments, the account manager may receive session records from various PRIMEs and pay each of them on the same or different schedules. When paying the PRIMEs, the account manager may be configured to send the accumulated records for accounting purposes. In some embodiments, the account manager may send funds to the PRIME after updating the account balance as in step 480 without waiting for multiple session records to accumulate. The account manager may be configured to operate in differently with different PRIMEs, depending upon the requirements of the PRIME. For example, one PRIME may require immediate payment of sent session records while another PRIME may prefer receiving periodic payments of multiple session records.

Although several embodiments have been illustrated and described in detail, it will be recognized that modifications and substitutions are possible without departing from the spirit and scope of the appended claims.

What is claimed is:

1. A method for communication account management, comprising:
receiving a notification of a first communication number from a first prime provider of a first institution, the first communication number entered by a first inmate at the first institution and the first communication number associated with a first user with which the first inmate desires to communicate;
determining a first account associated with the first communication number in response to receiving the notification of the first communication number;
in response to determining that the first communication number is associated with the first account, determining whether the first account comprises sufficient funding for a first communication session involving the first communication number;
sending a first message to the first prime provider indicating that the first account comprises sufficient funding for the first communication session;
receiving a notification of a second communication number from the first prime provider of the first institution, the second communication number entered by the first inmate at the first institution and the second communication number associated with a user with which the first inmate desires to communicate;
determining that the second communication number is associated with the first account in response to receiving the notification of the second communication number; and
in response to determining that the second communication number is associated with the first account, sending a second message to the first prime provider indicating that a communication session to the second communication number may proceed.

2. The method of claim 1, further comprising:
receiving a notification of a third communication number from the first prime provider of the first institution, the third communication number entered by the first inmate at the first institution and the third communication number associated with a second user with which the first inmate desires to communicate;
determining that the first account is associated with the third communication number in response to receiving the notification of the third communication number; and
in response to determining that the third communication number corresponds to a communication number of the plurality of communication numbers of the first account with which the first inmate is associated, sending a third message to the second prime provider indicating that a communication session to the third communication number may proceed.

3. The method of claim 1, further comprising:
receiving a notification of a third communication number from a second prime provider of a second institution, the third communication number entered by the first inmate at the second institution;
determining that the third communication number is associated with the first account in response to receiving the notification of the third communication number; and
in response to determining that the third communication number is associated with the first account, sending a third message to the second prime provider indicating that a communication session to the third communication number may proceed.

4. The method of claim 1, further comprising:
receiving a notification of a third communication number from the first prime provider of the first institution, the third communication number entered by a second inmate at the first institution;
determining that the third communication number is associated with the first account in response to receiving the notification of the third communication number; and
in response to determining that the third communication number is associated with the first account, sending a message to the first prime provider indicating that a communication session to the third communication number may proceed.

5. The method of claim 1, further comprising:
receiving a notification of a third communication number from a second prime provider of a second institution, the third communication number entered by a second inmate at the second institution;
determining that the third communication number is associated with the first account in response to receiving the notification of the third communication number; and
in response to determining that the third communication number is associated with the first account, sending a message to the second prime provider indicating that a communication session to the third communication number may proceed.

6. The method of claim 1, further comprising:
receiving a first session record from the first prime provider after sending the first message to the first prime provider, the first session record comprising information regarding the first communication session;
reducing a value of the first account in response to the first session record;
receiving a second session record from the first prime provider after sending the second message to the first prime provider, the second session record comprising information regarding the communication session to the second communication number; and
reducing the value of the first account in response to the second session record.

7. The method of claim 1, wherein determining whether the first account comprises sufficient funding for the first communication session involving the first communication number comprises determining whether the first account comprises sufficient funds to pay for an amount specified in the notification of the first communication number.

8. A method for communication account management, comprising:
receiving a notification of a first communication number from a first prime provider of a first institution, the first communication number entered by a first inmate at the first institution and the first communication number associated with a first user with which the first inmate desires to communicate;
determining that the first communication number is associated with a first account in response to receiving the notification of the first communication number;
in response to determining that the first communication number is associated with the first account, determining whether the first account comprises sufficient funding for a first communication session involving the first communication number;
sending a first message to the first prime provider indicating that the first account comprises sufficient funding for the first communication session;
receiving a second notification of the first communication number from the first prime provider of the first institution, the first communication number entered by a second inmate at the first institution;
determining that the first communication number is associated with the first account in response to receiving the second notification; and
in response to determining that the first communication number is associated with the first account, sending a second message to the first prime provider indicating that a communication session to the first communication number involving the second inmate may proceed.

9. The method of claim 8, further comprising:
receiving a third notification of the first communication number from a second prime provider of a second institution, the first communication number entered by a third inmate at the second institution;
determining that the first communication number is associated with the first account in response to receiving the third notification; and
in response to determining that the first communication number is associated with the first account, sending a message to the second prime provider indicating that a communication session to the first communication number may proceed.

10. The method of claim 8, further comprising:
receiving a notification of a second communication number from a second prime provider of a second institution, the second communication number entered by a third inmate at the second institution;
determining that the second communication number is associated with the first account in response to the notification of the second communication number; and
in response to determining that the second communication number corresponds to a communication number of the plurality of communication numbers of the first account with which the third inmate is associated, sending a message to the second prime provider indicating that a communication session to the third communication number may proceed.

11. The method of claim 8, further comprising:
receiving a first session record from the first prime provider after sending the message to the first prime provider, the first session record comprising a duration of the first communication session;
reducing a value of the first account in response to the duration of the first communication session;
receiving a second session record from the first prime provider after sending the second message to the first prime provider, the session record comprising a duration of the communication session involving the second inmate; and
reducing the value of the first account in response to the duration of the communication session involving the second inmate.

12. The method of claim 8, wherein determining whether the first account comprises sufficient funding for the first communication session involving the first communication number comprises determining whether the first account comprises sufficient funds to pay for an amount specified in the notification of the first communication number.

13. A system for communication account management, comprising:
a database comprising a first account; and
at least one processor coupled to the database and operable to:
receive a notification of a first communication number from a first prime provider of a first institution, the first communication number entered by the first inmate at the first institution and the first communication number associated with a first user with which the first inmate desires to communicate;
determine that the first communication number is associated with the first account in response to receiving the notification of the first communication number;
in response to determining that the first communication number is associated with the first account, determine whether the first account comprises sufficient funding for a first communication session involving the first communication number;
send a first message to the first prime provider indicating that the first account comprises sufficient funding for the first communication session;
receive a notification of a second communication number from the first prime provider of the first institution, the second communication number entered by the first inmate at the first institution and the second communication number associated with a user with which the first inmate desires to communicate;
determine that the second communication number is associated with the first account in response to receiving the notification of the second communication number; and
in response to determining that the second communication number is associated with the first account, send a second message to the first prime provider indicating that a communication session to the second communication number may proceed.

14. The system of claim 13, wherein the at least one processor is operable to:
receive a notification of a third communication number from the first prime provider of the first institution, the third communication number entered by the first inmate at the first institution and the third communication number associated with a second user with which the first inmate desires to communicate;
determine that the third communication number is associated with the first account in response to receiving the notification of the third communication number; and
in response to determining that the third communication number is associated with the first account, send a third message to the second prime provider indicating that a communication session to the third communication number may proceed.

15. The system of claim 13, wherein the at least one processor is operable to:
receive a notification of a third communication number from a second prime provider of a second institution, the third communication number entered by the first inmate at the second institution;
determine that the third communication number is associated with the first account in response to receiving the notification of the third communication number; and
in response to determining that the third communication number is associated with the first account, send a third message to the second prime provider indicating that a communication session to the third communication number may proceed.

16. The system of claim 13, wherein the at least one processor is operable to:
receive a notification of a third communication number from the first prime provider of the first institution, the third communication number entered by a second inmate at the first institution;
determine that the third communication number is associated with the first account in response to receiving the notification of the third communication number; and
in response to determining that the third communication number is associated with the first account, send a message to the first prime provider indicating that a communication session to the third communication number may proceed.

17. The system of claim 13, wherein the at least one processor is operable to:
receive a notification of a third communication number from a second prime provider of a second institution, the third communication number entered by a second inmate at the second institution;
determine that the third communication number is associated with the first account in response to receiving the notification of the third communication number; and
in response to determining that the third communication number is associated with the first account, send a message to the second prime provider indicating that a communication session to the third communication number may proceed.

18. The system of claim 13, wherein the at least one processor is operable to:
receive a first session record from the first prime provider after sending the first message to the first prime provider, the first session record comprising a duration of the first communication session;
reduce a value of the first account in response to the duration of the first communication session;
receive a second session record from the first prime provider after sending the second message to the first prime provider, the second session record comprising a duration of the communication session to the second communication number; and
reduce the value of the first account in response to the duration of the communication session to the second communication number.

19. The system of claim 13, wherein the at least one processor operable to determine whether the first account comprises sufficient funding for the first communication session involving the first communication number comprises at least one processor operable to determine whether the first account comprises sufficient funds to pay for an amount specified in the notification of the first communication number.

20. A system for communication account management, comprising:
a database comprising a first account; and
at least one processor coupled to the database and operable to:
receive a notification of a first communication number from a first prime provider of a first institution, the first communication number entered by a first inmate at the first institution and the first communication number associated with a first user with which the first inmate desires to communicate;
determine that the first communication number is associated with the first account in response to receiving the notification of the first communication number;
in response to determining that the first communication number is associated with the first account, determine whether the first account comprises sufficient funding for a first communication session involving the first communication number;
send a first message to the first prime provider indicating that the first account comprises sufficient funding for the first communication session;
receive a second notification of the first communication number from the first prime provider of the first institution, the first communication number entered by a second inmate at the first institution;
determine that the first communication number is associated with the first account in response to receiving the second notification of the first communication number; and
in response to determining that the first communication number is associated with the first account, send a second message to the first prime provider indicating that a communication session to the first communication number involving the second inmate may proceed.

21. The system of claim 20, wherein the at least one processor is operable to:
receive a third notification of the first communication number from a second prime provider of a second institution, the first communication number entered by a third inmate at the second institution;
determine that the first communication number is associated with the first account in response to receiving the third notification of the first communication number; and
in response to determining that the first communication number is associated with the first account, send a message to the second prime provider indicating that a communication session to the first communication number may proceed.

22. The system of claim 20, wherein the at least one processor is operable to:
receive a notification of a second communication number from a second prime provider of a second institution, the second communication number entered by a third inmate at the second institution;
determine that the second communication number is associated with the first account in response to receiving the notification of the second communication number; and
in response to determining that the second communication number is associated with the first account, send a message to the second prime provider indicating that a communication session to the third communication number may proceed.

23. The system of claim 20, wherein the at least one processor is operable to:
receive a first session record from the first prime provider after sending the message to the first prime provider, the first session record comprising information regarding the first communication session;
reduce a value of the first account in response to the first session record;
receive a second session record from the first prime provider after sending the second message to the first prime provider, the session record comprising information regarding the communication session involving the second inmate; and
reduce the value of the first account in response to the second session record.

24. The system of claim 20, wherein the at least one processor operable to determine whether the first account comprises sufficient funding for the first communication session involving the first communication number comprises at least one processor operable to determine whether the first account comprises sufficient funds to pay for an amount specified in the notification of the first communication number.

25. At least one computer-readable storage medium comprising executable instructions, wherein the executable instructions, when executed by at least one processor, are operable to:
receive a notification of a first communication number from a first prime provider of a first institution, the first communication number entered by a first inmate at the first institution and the first communication number associated with a first user with which the first inmate desires to communicate;
determine that the first communication number is associated with a first account in response to receiving the notification of the first communication number;
in response to determining that the first communication number is associated with the first account, determine whether the first account comprises sufficient funding for a first communication session involving the first communication number;
send a first message to the first prime provider indicating that the first account comprises sufficient funding for the first communication session;
receive a notification of a second communication number from the first prime provider of the first institution, the second communication number entered by the first inmate at the first institution and the second communication number associated with a user with which the first inmate desires to communicate;
determine that the second communication number is associated with the first account in response to receiving the notification of the second communication number; and
in response to determining that the second communication number is associated with the first account, send a second message to the first prime provider indicating that a communication session to the second communication number may proceed.

26. At least one computer-readable storage medium comprising executable instructions, wherein the executable instructions, when executed by at least one processor, are operable to:
receive a notification of a first communication number from a first prime provider of a first institution, the first communication number entered by a first inmate at the first institution and the first communication number associated with a first user with which the first inmate desires to communicate;
determine that the first communication number is associated with a first account in response to receiving the notification of the first communication number;
in response to determining that the first communication number is associated with the first account, determine whether the first account comprises sufficient funding for a first communication session involving the first communication number;
send a first message to the first prime provider indicating that the first account comprises sufficient funding for the first communication session;
receive a second notification of the first communication number from the first prime provider of the first institution, the first communication number entered by a second inmate at the first institution;
determine that the first communication number is associated with the first account in response to receiving the second notification of the first communication number; and
in response to determining that the first communication number is associated with the first account, send a second message to the first prime provider indicating that a communication session to the first communication number may proceed.
